(19) United States
(12) Patent Application Publication
(10) Pub. No.: US 2025/0133095 A1
(43) Pub. Date: Apr. 24, 2025

(54) NETWORK INTRUSION DETECTION

(71) Applicant: Oracle International Corporation, Redwood City, CA (US)

(72) Inventors: Jay Rajput, Bengaluru (IN); Virendra Singh, Bengaluru (IN); Abhilash Valappil Kunnummal, Apex, NC (US); John Mohan Raj, Bangalore (IN)

(21) Appl. No.: 18/492,278

(22) Filed: Oct. 23, 2023

(51) Int. Cl. H04L 9/40; G08B 21/18; H04L 43/16

(52) U.S. Cl. CPC H04L 63/1416; G08B 21/182; H04L 43/16; H04L 2463/146

(57) ABSTRACT

Various embodiments of the present technology generally relate to systems and methods for network intrusion detection. In certain embodiments, a network traffic analysis system may comprise one or more processors, and a memory having stored thereon instructions. The instructions, upon execution, may cause the one or more processors to receive, from a first network function (NF) in a communication exchange on a 5G network, a first copy of traffic from the communication exchange, determine whether a second copy of traffic corresponding to the first copy of traffic has been received from a second NF in the communication exchange, and in response to not receiving the second copy of traffic, issue a security notification to the first NF indicating a network intrusion.

### TECHNICAL FIELD

Various embodiments of the present technology generally relate to security within communications networks. More specifically, embodiments of the present technology relate to systems and methods for the detection of malicious network intrusions.

### BACKGROUND

Malicious access by unauthorized parties (e.g., “hackers”) to communication networks is a concern for network operators. For example, a hacker may gain access to a 5GC (5G core) network system by impersonating an NF (network function), which may be a module or component of the 5GC that performs defined operations within the 5G network. By impersonating an NF, the hacker may access 5G NF topology data, discover 5G NFs, request OAuth (Open Authentication) 2.0 access tokens, or access producer NF data.

New vulnerabilities are discovered regularly in authentication and access control performed by NF producers or consumers in networks such as 5GC network systems. These vulnerabilities can be exploited by a hacker to gain access to networks and send malicious messages to other NFs by spoofing a legitimate NF in the network. There are no current mechanisms to indicate whether or when a vulnerability on an NF producer or consumer is being exploited by a hacker. Such vulnerabilities, if undiscovered, can be exploited for extended periods, potentially causing serious harm or exposing significant data. Accordingly, there exists a need for improved network intrusion detection mechanisms.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for performing configuration data management. In an embodiment, a network traffic analysis system may comprise one or more processors, and a memory having stored thereon instructions. The instructions, upon execution, may cause the one or more processors to receive, from a first network function (NF) in a communication exchange on a 5G network, a first copy of traffic from the communication exchange, determine whether a second copy of traffic corresponding to the first copy of traffic has been received from a second NF in the communication exchange, and in response to not receiving the second copy of traffic, issue a security notification to the first NF indicating a network intrusion.

In some embodiments, the network traffic analysis system, in response to receiving the second copy of traffic, may determine that there is not a network intrusion. The communication exchange may include a service-based interface (SBI) exchange. In some examples, the network traffic analysis system may receive an SBI service request as the first copy of traffic, and determine whether a corresponding SBI service response is received as the second copy of traffic. In other examples, the network traffic analysis system may receive an SBI service response as the first copy of traffic, and determine whether a corresponding SBI service request is received as the second copy of traffic. In some embodiments, the first copy of traffic and the second copy of traffic include a same message sent and received by the first NF and the second NF in the communication exchange. The network traffic analysis system may perform hop-by-hop analysis of a traffic feed of the communication exchange to identify network intrusions, including receive the first copy of traffic, and evaluate incoming traffic to identify the second copy of traffic. Evaluating incoming traffic to identify the second copy of traffic may include comparing a consumer and a producer listed in the incoming traffic to the consumer and the producer listed in the first copy of traffic to identify corresponding traffic. In response to not receiving the second copy of traffic, the network traffic analysis system may determine a security failure in the communication exchange, increment a failure counter for the communication exchange, determine whether the failure counter is greater than a selected threshold, and when the failure counter is greater than the selected threshold, issue the security notification. In some embodiments, the network traffic analysis system may increment the failure counter only for consecutive security failures in the communication exchange.

In an alternative embodiment, a method may comprise operating a network traffic analysis system of a 5G network, including receiving, from a first network function (NF) in a communication exchange on the 5G network, a first copy of traffic from the communication exchange, determining whether a second copy of traffic corresponding to the first copy of traffic has been received from a second NF in the communication exchange, and issuing a security notification to the first NF indicating a network intrusion in response to not receiving the second copy of traffic.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to implement network intrusion detection, in accordance with certain embodiments of the present disclosure;

FIG. 2 depicts a flow diagram of an example method for network intrusion detection, in accordance with certain embodiments of the present disclosure;

FIG. 3 depicts a decision table of an example method for network intrusion detection, in accordance with certain embodiments of the present disclosure;

FIG. 4 depicts a flow diagram of an example method for network intrusion detection, in accordance with certain embodiments of the present disclosure;

FIG. 5 depicts a decision table of an example method for network intrusion detection, in accordance with certain embodiments of the present disclosure;

FIG. 6 depicts a flowchart of an example method for prevention of malicious service access over long-lived connections, in accordance with certain embodiments of the present disclosure; and

FIG. 7 is a diagram of a system configured to implement network intrusion detection, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

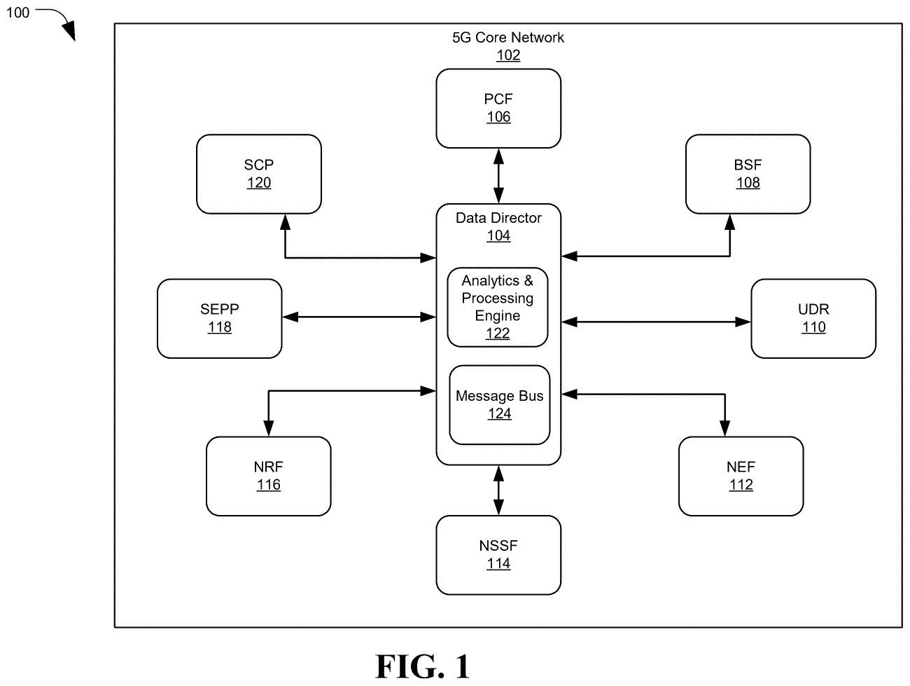

FIG. 1 is a diagram of a system 100 configured to implement network intrusion detection, in accordance with certain embodiments of the present disclosure. The example system 100 may include a network comprising a 5G core (5GC) cellular network 102 implementing 3GPP (3rd Generation Partnership Project) communication standards, although the present disclosure may apply to other communication networks.

Each or any of 5GC 102, its components, and their sub-components may be implemented via computers, servers, hardware and software modules, or other system components. The components of 5GC network 102 and its subcomponents, or the physical devices implementing them, may be co-located, remotely distributed, or any combination thereof. The elements of system 100 may include components hosted or situated in the cloud, and implemented as software modules potentially distributed across one or more server devices or other physical components.

The 5GC network 102 may include a plurality of example components, nodes, or network functions (NFs), including Policy Control Function (PCF) 106, Binding Support Function (BSF) 108, User Data Repository (UDR) 110, Network Exposure Function (NEF) 112, Network Slice Selection Function (NSSF) 114, Network Repository Function or NF Repository Function (NRF) 116, Security Edge Protection Proxy (SEPP) 118, or Service Controller Proxy or Service Communications Proxy (SCP) 120. The selection of NFs 106-120 depicted in system 100 is exemplary, and some of the NFs 106-120 may be excluded, or other NFs added to the collection, without departing from the scope of this disclosure. The various NFS 106-120 may execute various operations to provide communication services to user equipment (UE) that connects to 5GC network 102. A network node or NF that provides service may be referred to as a producer NF, while a network node or NF that consumes services may be referred to as a consumer NF. A network function can be both a producer NF and a consumer NF depending on whether it is consuming or providing service.

The NFs 106-120 of the 5GC network 102 may exchange various communications in the course of providing network services. The communications may include messaging to establish or end secured communication channels, such as transport layer security (TLS) handshakes, as well as service based interface (SBI) communications.

SBI may be the term given to the application programming interface (API) based communication that can take place between two NFs within the 5G SBA (Service Based Architecture). A given NF can utilize an API call over the SBI in order to invoke a particular service or service operation. Communications between NFs 106-120 may be performed over network links and communication channels of 5GC network 102 that are not explicitly depicted in system 100.

The 5GC network 102 may also include a data director (DD) 104. A DD 104 may be a network traffic analysis entity deployed in the 5GC network 102, which may receive a copy of traffic feeds from the NFs 106-120 deployed in the network 102, and may analyze the traffic and provide feedback to the NFs. An example DD 104 may include an Oracle® Communications Network Analytics Data Director (OCNADD), although other implementations of a DD are encompassed by this disclosure. The DD 104 may receive a copy of all communication traffic between NFs 106-120, or only certain types or categories of communications, such as SBI traffic. The examples provided herein may focus on implementations in which the NFs 106-120 send a copy of SBI traffic to the DD 104, although other implementations are possible. The data director 104 may include a message bus 124 to manage incoming traffic and outgoing responses or feedback, and an analytics and processing engine 122 to evaluate received traffic and messages, and to formulate feedback or notifications to provide back to NFs 106-120.

When NFs 106-120 communicate with each other, they may send a copy of the 5G SBI traffic to the data director 104. The NFs 106-120 and the DD 104 of 5GC network 102 may be provided or controlled by one or more network operators. The NFs 106-120 may be configured by the network operator to communicate with DD 104, and vice-versa, via special secure connections or communication channels that are not used for communications between the NFs 106-120 themselves. The DD 104 may be configured with security measures or requirements, such that entities outside of the 5GC network 102 run by a network operator, such as a hacker, may not know of or have means to send messages to DD 104.

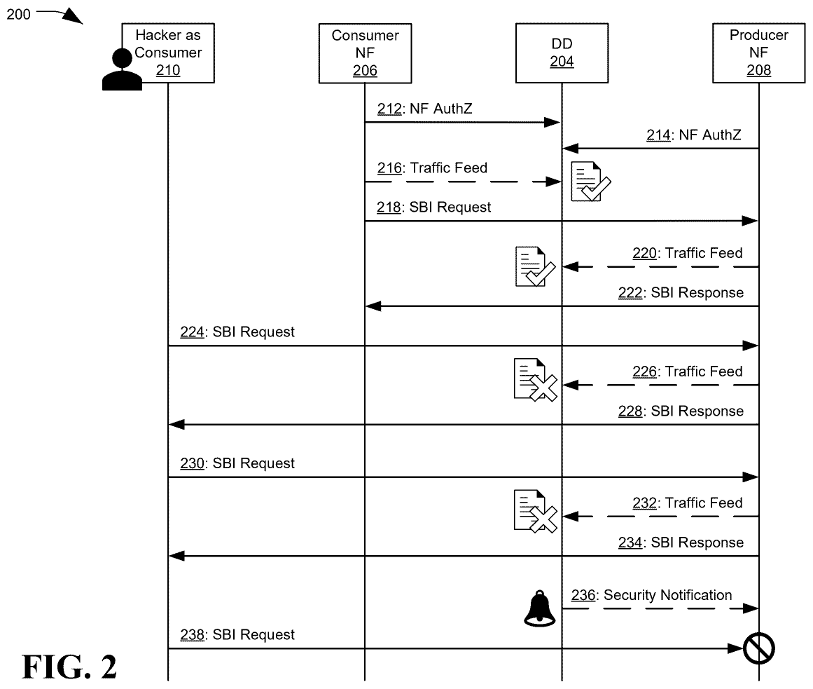

Based on the received SBI traffic, the DD 104 may analyze the traffic flow and determine when an unauthorized entity is communicating with the 5GC network 102. The DD 104 may perform hop-by-hop or other analysis to determine whether a proper message flow is occurring between authorized NFs. Hop-by-hop analysis may include analyzing a path through a network of data packets or communications as they move from entity to entity (such as NFs, switches, routers, etc.). Typical SBI communications include a first (consumer) NF sending a request to a second (producer) NF, and the second NF issuing a response to the first NF. The DD 104 may be configured to match request and response messages to determine whether an SBI communication is proper, or involves an unauthorized entity. DD 104 may receive messages from both NF consumers and NF producers, and can analyze the number of messages sent to the number of message received to determine whether all the message received are from a legitimate source or not. Since a hacker should not have access to the DD 104 itself due to DD-specific security procedures, any message sent by a hacker directly towards a legitimate NF may not be counted in the DD analysis, and thus may be highlighted as a mismatch. For example, if an authorized or legitimate NF in the 5GC network 102 is sending a copy of its own traffic to DD 104, but the other NF in the communication is not sending a copy of its traffic (e.g., due to being a hacker or other unauthorized entity without access to the DD), the DD may determine that there has been a network intrusion by an unauthorized entity. The DD 104 may then inform or notify one or more NFs about the intrusion or unauthorized entity to prevent further network intrusion, for example by directing the NFs to take appropriate security actions based on operator configuration of the NF. An example process flow to detect network intrusion is depicted in regard to FIG. 2.

FIG. 2 depicts a flow diagram 200 of an example method for network intrusion detection, in accordance with certain embodiments of the present disclosure. In particular, diagram 200 depicts a communication flow between systems in a 5GC network, in which a hacker 210 gains access to the network. The entities involved in the process flow may include a DD 204, a consumer NF 206, a producer NF 208, and the hacker 210. The components in diagram 200 may correspond to elements described in regard to FIG. 1.

At 212, consumer NF 206 may perform an authorization (AuthZ) or similar registration or authentication operation with DD 204. The AuthZ operation may grant the consumer NF 206 access rights and privileges to communicate with DD 204, and enable the DD 204 to send notifications or instructions to the consumer NF 204. At 214, the producer NF 208 may likewise perform an NF AuthZ operation with the DD 204. Based on these AuthZ operations, the NFs may send the DD 204 copies of SBI traffic or other communications in which the NFs are involved. The NFs may send copies of only communications they send (e.g., either requests or responses issued by the NF itself), they may send copies of only communications they receive, or they may send copies of both communications they send and communications they receive. The copies of the communications or traffic sent from an NF to the DD 204 may include information or details about the entities involved in the communication exchange, such as addresses or identifiers for both NFs in the exchange, TLS certificate details, or other information. Traffic feed communications sent or copied to the DD 204, or notifications sent from the DD to an NF, may be depicted in FIG. 2 using dashed line arrows. Communications or traffic between NFs in the network may be depicted using solid line arrows.

Accordingly, at 216, consumer NF 206 may send a traffic feed communication to DD 204. The traffic feed 216 may be a copy of another communication the consumer NF 206 is concurrently sending, or will or has sent in close temporal proximity. In the depicted example, traffic feed 216 may be a copy of an SBI request 218 the consumer NF 206 is sending to producer NF 208. The DD 204 may receive the traffic feed 216, and determine it is a request from an authorized NF. The DD 204 may therefore decide that the communication is valid (indicated by a check-marked box on FIG. 2), or it may wait to receive a corresponding response or a copy of the SBI request 218 received from the target producer NF 208. For example, the DD 204 may wait to decide that a communication exchange is valid until it has received a matching pair of communications from both a sender and receiver NF. In examples where NFs send only a copy of the communications they issue, the DD 204 may look to match a request and response. In examples where NFs send both a copy of the messages they send and the messages they receive, the DD 204 may match a copy of a request sent by consumer NF 206 to a request received by producer NF 208 (and may perform the same match for any SBI communication sent and received between two NFs). In the example of system 200, it may be assumed the NFs are only sending the DD 204 copies of messages they send, and not a copy of messages they receive.

As noted above, the consumer NF 206 may send the SBI request 218 to producer NF 208. In response, the producer NF 208 may prepare and send an SBI response 222 back to consumer NF 206, and send a copy of the response to DD 204 via traffic feed 220. At this point, the DD 204 may have received a matching pair of request and response messages from authorized NFs, consumer NF 206 and producer NF 208. The DD 204 may then determine that the message exchange was valid between authorized NFs within the 5GC network. Based on validating the exchange, the DD 204 may send no notification to consumer NF 206 and producer NF 208, or in some implementations, the DD may send them a notification that the communication was valid.

A hacker 210 may gain access to the 5GC network by impersonating a consumer or producer NF. In the example of system 200, the hacker 210 may impersonate a consumer NF. The hacker 210 may gain access to the network using credentials associated with a legitimate NF in the network. For example, the hacker 210 may steal or otherwise obtain a copy of a private key and certificate issued by a public key infrastructure (PKI) system and used in TLS or other security protocols and use those credentials to impersonate the legitimate NF from which they were taken. If the stolen credentials have not been reported to the PKI system or otherwise revoked, detecting the hacker's intrusion may be difficult.

At 224, the hacker-as-consumer 210 may issue an SBI request to producer NF 208. However, the hacker 210 may not have access to DD 204, either by being unaware of the DD or lacking the ability to be authorized with the DD. Accordingly, the hacker 210 may not send a copy of its SBI request 224 to DD 204. In response to the impersonated SBI request 224, the producer NF 208 may prepare and issue an SBI response 228 to the hacker 210, while sending a copy of the communication to the DD 204. Because the DD 204 has received a copy of an SBI response 228 without receiving a corresponding SBI request, the DD may determine the exchange is invalid and that a network intrusion has occurred. The determination that a communication evaluation failed may be indicated by a crossed-out box on FIG. 2.

At 230, the hacker-as-consumer NF 210 may issue a second SBI request to the producer NF 208, and the producer NF may send an SBI response 234 back to the hacker, with a copy of the traffic feed 232 sent to the DD 204. Once again, the DD 204 may determine that there is not a matching pair of communications, and that the communication authentication has failed. Accordingly, at 236, the DD 204 may issue a security notification 236 that a network intrusion has been determined and the communications with hacker 210 have not been authenticated or validated. The security notification 236 may direct the producer NF 208 to take appropriate security operations, as set by a network operator for the producer NF, to prevent a next SBI request 238 from hacker 210.

Security operations taken by an NF in response to a security notification 236 may include closing a TLS session with the hacker 210, for example by issuing a Transmission Control Protocol (TCP) FIN or GOAWAY message. The notification 236 from the DD 204 may provide the producer NF 208 with an identifier for the hacker 210 or the compromised communication session or channel. For example, the notification 236 may identify a security certificate used by the hacker 210 in the communication session, which the producer NF 208 may ignore or block if the hacker 210 attempts to establish another communication session. Other security operations are also possible.

In the depicted example of flow diagram 200, the DD 204 may send the security notification 236 after two unvalidated message exchanges, at 226 and 232. The DD 204 may be configured to send a notification after a single unvalidated exchange, or after multiple unvalidated exchanges involving the same NFs. The reason a higher number may be set may be to account for potential packet or message loss, so that valid connections between NFs are not cut off simply because a single or small number of traffic feed messages were lost in transmission. Even if the security notification threshold is set at a low number, there may be a delay at the DD 204 for processing message exchanges and determining whether a network intrusion has occurred, and then generating and sending the security notification 236. Accordingly, security notification 236 may correspond to the first unvalidated traffic feed 226, but an additional exchange occurred between hacker 210 and producer NF 208 before the first exchange was processed and the notification was sent.

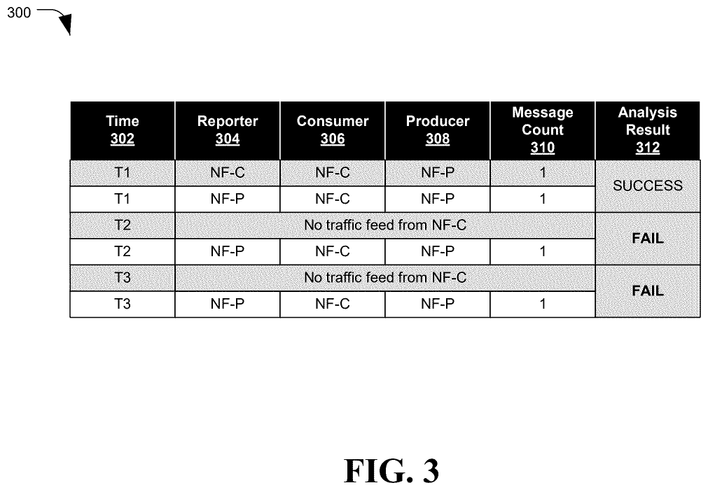

In some example embodiments, the DD 204 may notify additional entities of the intrusion beyond the producer NF 208 involved in the communication. For example, the DD 204 may notify a network operator administrator, e.g., by sending a text or email, including details of the communications that revealed the intrusion. The administrator may then be able to take remedial action, such as to remove a malicious entity from the network, notify law enforcement, or notify a PKI system about a compromised certificate or other credentials used by the hacker 210, so that those credentials can be revoked. In some examples, the DD 204 may be configured to notify a PKI system directly about compromised credentials. The DD 204 may notify NFs in the 5GC network that handle significant routing or lookup duties that would be utilized by hacker 210, such as an NRF 116, which may maintain a repository of the NF elements of the 5GC network and service discovery requests for NF producers, or an SCP 120, which may obtain reachability and service profile information regarding producer NF service instances, and load balance traffic among producer NF service instances. A method by which a DD 204 may monitor for network intrusion is discussed in regard to FIG. 3.

FIG. 3 depicts a decision table 300 of an example method for network intrusion detection, in accordance with certain embodiments of the present disclosure. In particular, table 300 depicts a record of messages exchanged between NFs in a 5GC network, with the messages corresponding to the flow diagram of FIG. 2. The table 300 may represent an analysis process performed by a data director, such as DD 104 of FIG. 1 or DD 204 of FIG. 2. Table 300 may represent a log or other data structure maintained by a DD, or the table 300 may be a visual representation of the comparisons performed by a DD. Decision table 300 may include a “time” column 302, a “reporter” column 304, a “consumer” column 306, a “producer” column 308, a “message count” column 310, and an “analysis result” column 312.

The time column 302 may list time values such as T1, T2, and T3. The time values may be an abstraction of the flow of events depicted in flow diagram of FIG. 2, with T1 encompassing a period of time including messages 216 to 220, T2 encompassing a period of time including messages 224 to 226, and T3 encompassing a period of time including messages 230 to 232. The first message row for each T value may represent the request from a consumer NF, while the second message row for each T value may represent the response from a producer NF. The DD may attempt to match messages based on the NFs involved in the exchange, message identifiers, types of communications (e.g., type of request and corresponding type of response), and may also be based on time frame. For example, a request and corresponding response should be expected to occur (and copies of the traffic received by the DD) within a specified time frame (e.g., 1 second). However, a DD may be receiving hundreds or thousands of traffic events per second, and a request and corresponding response would not necessarily be received by a DD as sequential messages in time without other unrelated messages being received in-between. Accordingly, the T1, T2, etc. designations in table 300 may be abstractions for simplicity.

The reporter column 304 may represent which NF sent the traffic copy to the DD. An NF-C value may represent an identifier for a specific consumer NF, such as a node identifier name or number, network address, or other identifying value. Similarly, an NF-P value may represent an identifier for a specific producer NF. As discussed above, in some implementations the NFs may be configured to only send the DD a copy of traffic sent by that NF itself, and not send traffic received by that NF. In other implementations, NFs may send a copy of traffic they receive, or may send copies of both sent and received traffic. In either event, when a request-response exchange is performed between valid authorized NFs, the DD should expect to receive matching or corresponding traffic copies from both NFs in the exchange. The DD may compare received traffic to find matching sets of transmissions reported by both NFs in the exchange to validate the transmissions. When a traffic transmission is received from one reporter 304 without the DD receiving a corresponding transmission reported by the other NF, it may indicate an intrusion in the network has occurred.

The consumer column 306 may represent the consumer NF in a transmission exchange, while a producer NF 308 may represent the producer NF in an exchange. As discussed above, the NF-C and NF-P values may represent identifiers for particular consumer or producer NFs, respectively. Both consumer and producer NFs may be listed in a traffic copy sent to the DD, regardless of which NF the reporter 304 is. The DD may attempt to match transmissions based on matching consumer 306 and producer 308 listed in the transmission.

The message count column 310 may represent a number corresponding to traffic messages received at the DD, or reported by the consumer 306 and producer 308 NFs. In some examples, the value may be “1” for each message, and the DD may determine whether it has received an even number of corresponding messages for an exchange. For example, a request with value “1” plus a corresponding response with value “1” adds up to an even value, 2. If an odd number of messages are received for an exchange, it may indicate a message mis-match or missing messages, which may indicate an unvalidated exchange or network intrusion. In some examples, the message count 310 may be a number of messages reported by each of a consumer 306 and producer 308 in a communication exchange, and the DD may determine whether the reported message count matches. If one entity in an exchange reports a number of messages and the other entity reports none, it may indicate an intrusion. In other examples, message count 310 may be used to represent a pair of numbered message identifiers, such as if a request has a first ID number, and the producer NF is configured to generate a response with the same ID, or an incremented, hashed, permuted, or otherwise related ID value, so that a DD may be configured to match the messages based on message count 310 values. Other embodiments are also possible.

The analysis result column 312 may represent whether a matching or corresponding pair of messages was received at the DD. A “Success” value may indicate an even number or corresponding pair of messages were received, and therefore both messages may be validated. A “Fail” value may indicate that a traffic message was received without a matching or corresponding pair message, or an odd number of messages was received. This may indicate that one entity in the exchange is not a valid member of the 5GC network and may be an unauthorized intruder or hacker. A fail result may cause the DD to generate a security notification and send it to at least the reporter 304 for the mismatched message. In some examples, the DD may be configured to detect a threshold or selected number of failed exchanges for a given reporter NF or pair of communicating NFs before generating or sending a security notification.

Referring to both FIG. 2 and FIG. 3, time 302 T1 in table 300 may correspond to the message exchange between consumer NF 206 and producer NF 208. The first T1 message may correspond to traffic feed 216, with a reporter 304 of NF-C for consumer NF 206, identifying consumer 306 as consumer NF 206, and producer 308 as producer NF 208. The second T1 message may correspond to traffic feed 220, with reporter 304 of producer NF 208, and matching consumer 306 and producer 308 values to the first T1 message. Because the DD may be able to match the related T1 messages and the message counts 310 produce an even result, the DD may reach a “success” analysis result 312.

Time 302 T2 in table 300 may correspond to the message exchange between hacker 210 and producer NF 208 from messages 224 to 228. The first T2 message would correspond to the SBI request 224 from hacker 210 to producer NF 208. However, because the hacker 210 does not have access to the DD to send traffic, the DD did not receive a request message from a consumer NF, and the first T2 row is empty. The second T2 message corresponds to the response traffic feed 226 from producer NF 208 to hacker 210. Because the DD was unable to match a corresponding request and response pair, the message count 310 is uneven, and accordingly the DD may reach an analysis result 312 of “Fail.”

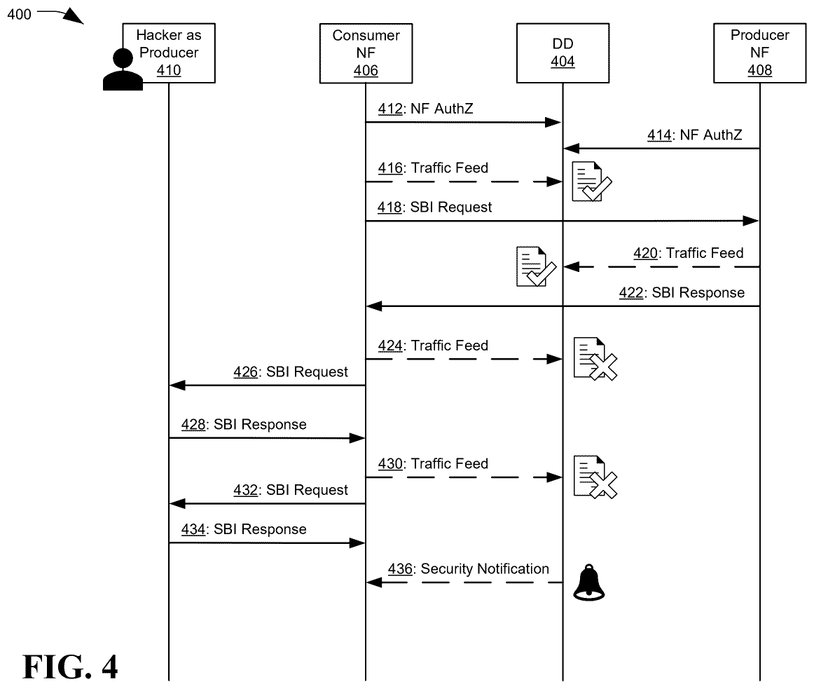

Similarly, time 302 T3 in table 300 may correspond to the message exchange between hacker 210 and producer NF 208 from messages 230 to 234. Once again, the DD does not receive a traffic feed from hacker 210, cannot match the request and response messages, and reaches an analysis result 312 of “Fail.” Two failures between the listed consumer 306 and producer 308 entities, potentially within a selected period of time, may reach a threshold for the DD to generate a security notification and send it to the unmatched reporter 304 from the failed exchanges. Another example flow diagram is depicted in FIG. 4.

FIG. 4 depicts a flow diagram 400 of an example method for network intrusion detection, in accordance with certain embodiments of the present disclosure. In particular, diagram 400 depicts a communication flow between systems in a 5GC network, in which a hacker 410 gains access to the network and impersonates a producer NF. The entities involved in the process flow may include a DD 404, a consumer NF 406, a producer NF 408, and the hacker 410. The components in diagram 400 may correspond to elements described in regard to FIG. 1 and FIG. 2.

The process flow in FIG. 4 may be similar the one described in regard to FIG. 2, including consumer NF 406 and producer NF 408 performing authorization operations with the DD 404 at 412 and 414, respectively, and then performing a request-and-response exchange, with traffic feeds provided to the DD, via exchanges 416-422. The authorized request and response exchange with valid NFs may be validated by the DD 404 for traffic feeds 416 and 420.

In the example of FIG. 4, the hacker 410 may impersonate (e.g., via stolen credentials) a producer NF. Accordingly, consumer NF 406 may send an SBI request 426 to the hacker 410 as an impersonated producer, and sends a copy of the traffic feed 424 to the DD 404. Because the DD 404 does not receive a corresponding traffic feed from hacker 410, the DD may determine that the traffic feed 424 is unvalidated and may represent a network intrusion, as indicated by the crossed-out box. The hacker 410 may provide an SBI response 428 to the SBI request 426, potentially by providing invalid or malicious information or service.

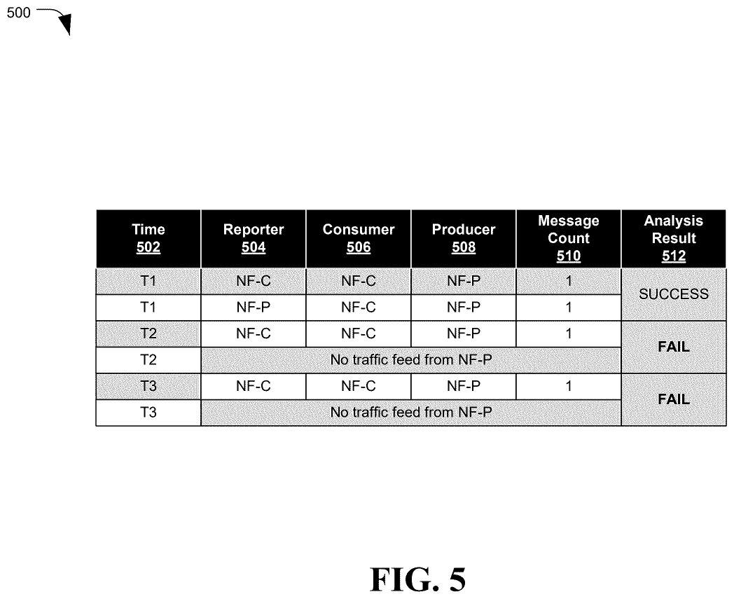

Similarly, the consumer NF 406 and hacker 410 may exchange a request and response, with the consumer NF providing a traffic feed copy, via messages 430 to 434. The DD 404 may once again determine that there was not a valid exchange associated with traffic feed 430, and determine that a network intrusion has occurred. The DD 404 may therefore send a security notification 436 to consumer NF 406, directing the consumer NF to take appropriate security measures and no longer issue SBI requests to hacker 410. An example system of the DD 404 evaluating the message flow 400 is described in regard to FIG. 5.

FIG. 5 depicts a decision table 500 of an example method for network intrusion detection, in accordance with certain embodiments of the present disclosure. In particular, table 500 depicts a record of messages exchanged between NFs in a 5GC network, with the messages corresponding to the flow diagram of FIG. 4. The table 500 may represent an analysis process performed by a data director, such as DD 104 of FIG. 1 or DD 404 of FIG. 4. Table 500 may represent a log or other data structure maintained by a DD, or the table 500 may be a visual representation of the comparisons performed by a DD. Decision table 500 may include a “time” column 502, a “reporter” column 504, a “consumer” column 506, a “producer” column 508, a “message count” column 510, and an “analysis result” column 512. The description of columns 502-512 may correspond to the columns of FIG. 3.

Referring to both FIG. 4 and FIG. 5, time 502 T1 in table 500 may correspond to the message exchange between consumer NF 406 and producer NF 408. The first T1 message may correspond to traffic feed 416, with a reporter 504 of NF-C for consumer NF 406, identifying consumer 506 as consumer NF 406, and producer 508 as producer NF 408. The second T1 message may correspond to traffic feed 420, with reporter 504 of producer NF 408, and matching consumer 506 and producer 508 values to the first T1 message. Because the DD may be able to match the related T1 messages and the message counts 510 produce an even result, the DD may reach a “success” analysis result 512.

Time 502 T2 in table 500 may correspond to the message exchange between consumer NF 406 and hacker 410, from messages 424 to 428. The first T2 message would correspond to the traffic feed 424, as a copy of the SBI request 426 from consumer NF 406 to hacker 410. As the message originated from a valid NF, it may be reported to the DD 404 correctly. However, the DD 404 may require a matching response to the received request before it can determine if the exchange is valid, or if a network intrusion may be involved. The second T2 message would correspond to the copy of the SBI response 428 from hacker 410 to consumer NF 406. However, because the hacker as producer 410 does not have access to the DD to send traffic, the DD did not receive the expected response message from a producer NF, and the second T2 row is empty. Because the DD was unable to match a corresponding request and response pair, the message count 510 is uneven, and accordingly the DD may reach an analysis result 512 of “Fail.”

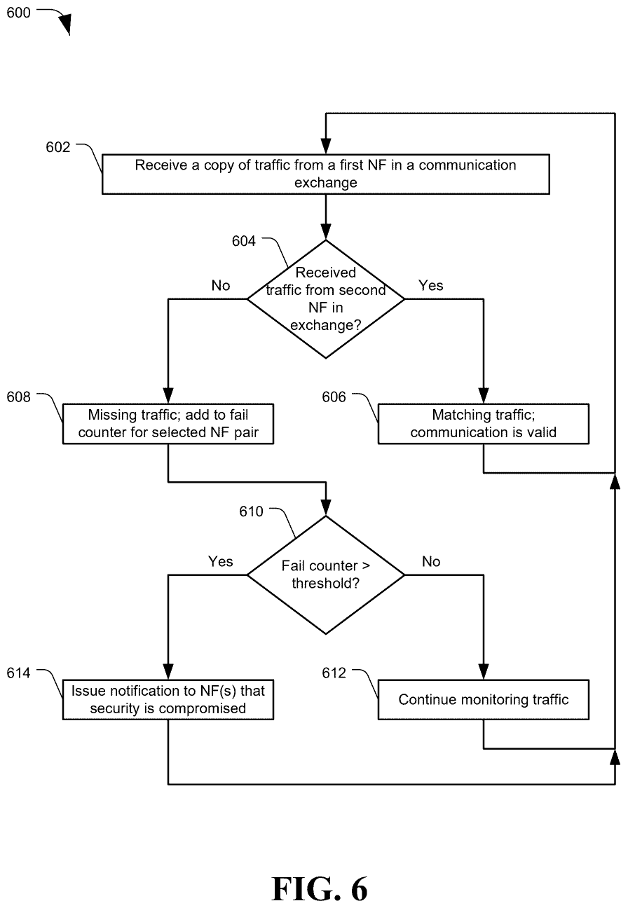

Similarly, time 502 T3 in table 500 may correspond to the message exchange between consumer NF 406 and hacker as producer 410 from messages 430 to 434. Once again, the DD may receive a copy of the request traffic feed 430 from the valid consumer NF, but does not receive a response traffic feed from hacker 410. Accordingly, the DD cannot match the request and response messages, and reaches an analysis result 512 of “Fail.” Two failures between the listed consumer 506 and producer 508 entities, potentially within a selected period of time, may reach a threshold for the DD to generate a security notification and send it to the unmatched reporter 504 from the failed exchanges. An example method of intrusion detection is described in regard to FIG. 6.

FIG. 6 depicts a flowchart 600 of an example method for network intrusion detection, in accordance with certain embodiments of the present disclosure. In particular, flowchart 600 depicts an example process implemented by a data director to monitor network intrusions based on received traffic feed information received from one or more NFs in a 5GC network. The method of FIG. 6 may be performed by DD 104 of FIG. 1, including analytics and processing engine 122 and message bus 124.

The method may include receiving a copy of traffic from a first NF in a communication exchange, at 602. The copy of traffic may include an exact copy or “carbon copy” of a message exchanged between a first NF and a second NF, or it may be a modified, condensed, or otherwise different version of the message, such as one including additional details on one or more of the involved NFs, a summary of message type and the NFs involved, certificate or credential details for one or more of the NFs, message IDs, timestamps, or other details that may be used by a DD to match corresponding messages and the NFs involved. Depending on implementation, the first NF may be an NF that sent the original of the traffic message, or an NF that received the traffic message.

At 604, the method may include determining whether the DD has received traffic from a second NF in the communication exchange. This may include determining whether the received traffic includes matching request and response pairs, that the NFs for each transmission are matching (including the role of each as consumer and producer), verifying that an even number of matching messages were received, or otherwise matching message pairs. If a matching set of traffic was received, the method may include determining that matching traffic was received, and the communication was valid, at 606. The DD may send no notification to the participant NFs, or may send a notification that the communication was valid. The method then may return to receiving additional traffic, at 602.

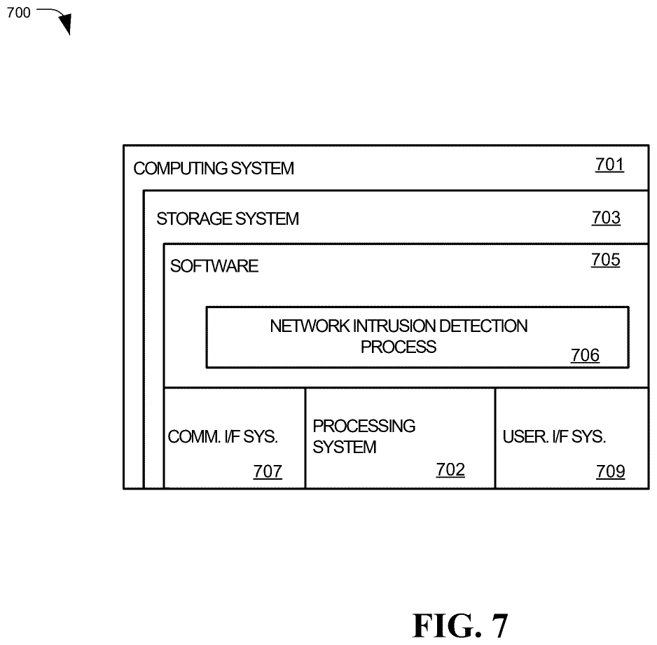

If no matching traffic was received from the second NF, at 604, the method may include determining that there was missing traffic, and adding to a fail counter for the selected NF pair, at 608, indicating a security failure in the communication exchange. A determination may then be made whether the fail counter is greater than a threshold, at 610. The threshold may be a single failure, or may be set to a higher value to account for one or more traffic messages being inadvertently lost in transmission. The fail threshold may only apply to consecutive failures. If the fail counter is not higher than the threshold, the method may include continuing to monitor traffic at 612, and receiving a next transmission at 602. However, if the fail counter is greater than the threshold, at 610, the method may include issuing a notification to the first NF that security is compromised or a network intrusion is detected at the second NF, at 614. In some embodiments, the DD may notify both NFs involved in the exchange, may send notifications to other NFs in the 5GC network regarding the second NF that did not provide copies of its traffic, or even notify administrators or outside entities (such as a PKI system) regarding the intrusion. The method may then proceed to receiving next traffic communications, at 602. A computing system configured to perform the operations and methods described herein is provided in regard to FIG. 7.

FIG. 7 is a diagram of a system configured to implement network intrusion detection, in accordance with certain embodiments of the present disclosure. System 700 may be an example of an apparatus including a computing system 701 that is representative of any system or collection of systems in which the various processes, systems, programs, services, and scenarios disclosed herein may be implemented. For example, computing system 701 may be an example data director 104, 204, or 404, consumer NF 206 or 406, producer NF 208 or 408, or any of the subcomponents depicted in system 100 of FIG. 1. Examples of computing system 701 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 701 may be implemented as a single apparatus, system, or device or may be implemented in a distributed manner as multiple apparatuses, systems, or devices. Computing system 701 may include, but is not limited to, processing system 702, storage system 703, software 705, communication interface system 707, and user interface system 709. Processing system 702 may be operatively coupled with storage system 703, communication interface system 707, and user interface system 709.

Processing system 702 may load and execute software 705 from storage system 703. Software 705 may include network intrusion detection process 706, which may be representative of any of the operations for monitoring SBI traffic to determine whether a network intrusion has occurred based on unmatched SBI communication pairs or sets, as discussed with respect to the preceding figures. When executed by processing system 702, software 705 may direct processing system 702 to operate as described herein for at least the various processes, operational scenarios, and sequences discussed in the foregoing implementations. Computing system 701 may optionally include additional devices, features, or functionality not discussed for purposes of brevity.

In some embodiments, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 may include general purpose central processing units, graphical processing units, application specific processors, and logic devices, as well as any other type of processing device, combinations, or variations thereof.

Storage system 703 may comprise any memory device or computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including network intrusion detection process 706 among other functions) may be implemented in program instructions that may, when executed by processing system 702, direct processing system 702 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system as described herein. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A network traffic analysis system, comprising:
one or more processors; and
a memory having stored thereon instructions that, upon execution by the one or more processors, cause the one or more processors to:
receive, from a first network function (NF) in a communication exchange on a 5G network, a first copy of traffic from the communication exchange;
determine whether a second copy of traffic corresponding to the first copy of traffic has been received from a second NF in the communication exchange; and
in response to not receiving the second copy of traffic, issue a security notification to the first NF indicating a network intrusion.

2. The network traffic analysis system of claim 1, further comprising:
in response to receiving the second copy of traffic, determine that there is not a network intrusion.

3. The network traffic analysis system of claim 2, wherein the communication exchange includes a service-based interface (SBI) exchange.

4. The network traffic analysis system of claim 3, further comprising:
receive an SBI service request as the first copy of traffic; and
determine whether a corresponding SBI service response is received as the second copy of traffic.

5. The network traffic analysis system of claim 3, further comprising:
receive an SBI service response as the first copy of traffic; and
determine whether a corresponding SBI service request is received as the second copy of traffic.

6. The network traffic analysis system of claim 3, wherein the first copy of traffic and the second copy of traffic include a same message sent and received by the first NF and the second NF in the communication exchange.

7. The network traffic analysis system of claim 3, further comprising:
perform hop-by-hop analysis of a traffic feed of the communication exchange to identify network intrusions, including:
receive the first copy of traffic; and
evaluate incoming traffic to identify the second copy of traffic.

8. The network traffic analysis system of claim 7, further comprising:
evaluate incoming traffic to identify the second copy of traffic, including:
compare a consumer and a producer listed in the incoming traffic to the consumer and the producer listed in the first copy of traffic to identify corresponding traffic.

9. The network traffic analysis system of claim 8, further comprising:
in response to not receiving the second copy of traffic,
determine a security failure in the communication exchange;
increment a failure counter for the communication exchange;
determine whether the failure counter is greater than a selected threshold; and
when the failure counter is greater than the selected threshold, issue the security notification.

10. The network traffic analysis system of claim 9, further comprising:
increment the failure counter only for consecutive security failures in the communication exchange.

11. A method comprising:
operating a network traffic analysis system of a 5G network, including:
receiving, from a first network function (NF) in a communication exchange on the 5G network, a first copy of traffic from the communication exchange;
determining whether a second copy of traffic corresponding to the first copy of traffic has been received from a second NF in the communication exchange; and
issuing a security notification to the first NF indicating a network intrusion in response to not receiving the second copy of traffic.

12. The method of claim 11, further comprising:
determining that there is not a network intrusion in response to receiving the second copy of traffic.

13. The method of claim 11, wherein the communication exchange includes a service-based interface (SBI) exchange.

14. The method of claim 13, further comprising:
receiving an SBI service request as the first copy of traffic; and
determining whether a corresponding SBI service response is received as the second copy of traffic.

15. The method of claim 13, further comprising:
receiving an SBI service response as the first copy of traffic; and
determining whether a corresponding SBI service request is received as the second copy of traffic.

16. The method of claim 13, wherein the first copy of traffic and the second copy of traffic include a same message sent and received by the first NF and the second NF in the communication exchange.

17. The method of claim 11, further comprising:
performing hop-by-hop analysis of a traffic feed of the communication exchange to identify network intrusions, including:
receiving the first copy of traffic; and
evaluating incoming traffic to identify the second copy of traffic.

18. The method of claim 17, further comprising:
evaluating the incoming traffic to identify the second copy of traffic, including:
comparing a consumer and a producer listed in the incoming traffic to the consumer and the producer listed in the first copy of traffic to identify corresponding traffic.

19. The method of claim 11, further comprising:
in response to not receiving the second copy of traffic,
determining a security failure in the communication exchange;
incrementing a failure counter for the communication exchange;
determining whether the failure counter is greater than a selected threshold; and
issuing the security notification when the failure counter is greater than the selected threshold.

20. The method of claim 19, further comprising:
incrementing the failure counter only for consecutive security failures in the communication exchange.
